(19) United States
(12) Patent Application Publication
(10) Pub. No.: US 2024/0176204 A1
(43) Pub. Date: May 30, 2024

(54) DISPLAY APPARATUS

(71) Applicant: Shanghai Tianma Micro-Electronics Co., Ltd., Shanghai (CN)

(72) Inventors: Hao WU, Shanghai (CN); Qijun YAO, Shanghai (CN)

(73) Assignee: Shanghai Tianma Micro-Electronics Co., Ltd., Shanghai (CN)

(21) Appl. No.: 18/432,455

(22) Filed: Feb. 5, 2024

(30) Foreign Application Priority Data
Aug. 3, 2023 (CN) 202310969206.4

(51) Int. Cl. G02F 1/1677; G02F 1/167; G02F 1/16753; G09G 3/34

(52) U.S. Cl. CPC G02F 1/1677; G02F 1/16753; G09G 3/344; G02F 1/167; G09G 2310/08; G09G 2320/0666

(57) ABSTRACT

Embodiments of the present disclosure relate to the display field and provide a display apparatus that combines functionality and aesthetics. The display apparatus includes a working area and a non-working area. The non-working area presents a first color or a first pattern. The display apparatus further includes a display module, and the display module includes a transparent display unit located in the working area.

### CROSS-REFERENCE TO RELATED DISCLOSURE

The present disclosure claims priority to Chinese Patent Disclosure No. 202310969206.4, filed on Aug. 3, 2023, the content of which is incorporated herein by reference in its entirety.

### TECHNICAL FIELD

The present disclosure relates to the technical field of displays, and in particular, to a display apparatus.

### BACKGROUND

With continuously growing aesthetic standards, users have higher expectations for the aesthetics and fashionability of display products in various fields such as vehicles and smart home. However, traditional designs of display products are no longer sufficient to meet users' demands.

### SUMMARY

In view of this, embodiments of the present disclosure provide a display apparatus that combines functionality and aesthetics.

The embodiments of the present disclosure provide a display apparatus including a working area and a non-working area. The non-working area presents a first color or a first pattern.

The display apparatus further includes a display module. The display module includes a transparent display unit located in the working area.

### BRIEF DESCRIPTION OF DRAWINGS

To describe the technical solutions in the embodiments of the present disclosure more clearly, the following briefly describes the accompanying drawings required to be used in the embodiments. Apparently, the accompanying drawings in the following description show merely some embodiments of the present disclosure, and a person of ordinary skill in the art may still derive other drawings from these accompanying drawings.

FIG. 1 is a schematic structural diagram of a display apparatus according to an embodiment of the present disclosure;

FIG. 2 is another schematic structural diagram of a display apparatus according to an embodiment of the present disclosure;

FIG. 3 is still another schematic structural diagram of a display apparatus according to an embodiment of the present disclosure;

FIG. 4 is a schematic diagram of a display apparatus corresponding to FIG. 1 in a first state;

FIG. 5 is a schematic diagram of a display apparatus corresponding to FIG. 2 in a first state;

FIG. 6 is a schematic diagram of a display apparatus corresponding to FIG. 3 in a first state;

FIG. 7 is a schematic diagram of a display apparatus corresponding to FIG. 1 in a second state;

FIG. 8 is a schematic diagram of a display apparatus corresponding to FIG. 2 in a second state;

FIG. 9 is a schematic diagram of a display apparatus corresponding to FIG. 3 in a second state;

FIG. 10 is yet another top view of a display apparatus according to an embodiment of the present disclosure;

FIG. 11 is a schematic diagram of a display apparatus corresponding to FIG. 10 in a third state;

FIG. 12 is another schematic diagram of a display apparatus corresponding to FIG. 10 in a third state;

FIG. 13 is a top view of a transparent display unit according to an embodiment of the present disclosure;

FIG. 14 is another top view of a transparent display unit according to an embodiment of the present disclosure;

FIG. 15 is still another top view of a transparent display unit according to an embodiment of the present disclosure;

FIG. 16 is a timing diagram of a display apparatus in a third state according to an embodiment of the present disclosure;

FIG. 17 is another timing diagram of a display apparatus in a third state according to an embodiment of the present disclosure;

FIG. 18 is yet another top view of a transparent display unit according to an embodiment of the present disclosure;

FIG. 19 is a schematic diagram of a display apparatus in a fourth state according to an embodiment of the present disclosure;

FIG. 20 is a cross-sectional view of a transparent display unit according to an embodiment of the present disclosure;

FIG. 21 is yet another top view of a display apparatus according to an embodiment of the present disclosure;

FIG. 22 is another cross-sectional view of a transparent display unit according to an embodiment of the present disclosure;

FIG. 23 is yet another top view of a display apparatus according to an embodiment of the present disclosure;

FIG. 24 is a schematic structural diagram of a display apparatus according to an embodiment of the present disclosure;

FIG. 25 is another schematic structural diagram of a display apparatus according to an embodiment of the present disclosure;

FIG. 26 is still another schematic structural diagram of a display apparatus according to an embodiment of the present disclosure;

FIG. 27 is a cross-sectional view of the display apparatus along A1-A2 shown in FIG. 26;

FIG. 28 is another cross-sectional view of the display apparatus along A1-A2 shown in FIG. 26;

FIG. 29 is a top view of a carrier module according to an embodiment of the present disclosure;

FIG. 30 is a schematic diagram of a segment difference between a first surface and a light exiting surface according to an embodiment of the present disclosure;

FIG. 31 is a schematic diagram of another segment difference between a first surface and a light exiting surface according to an embodiment of the present disclosure;

FIG. 32 is yet another cross-sectional view of a display apparatus according to an embodiment of the present disclosure;

FIG. 33 is a cross-sectional view of the display apparatus along B1-B2 shown in FIG. 32;

FIG. 34 is yet another cross-sectional view of a display apparatus according to an embodiment of the present disclosure;

FIG. 35 is a cross-sectional view of the display apparatus along C1-C2 shown in FIG. 34;

FIG. 36 is yet another schematic structural diagram of a display apparatus according to an embodiment of the present disclosure;

FIG. 37 is a cross-sectional view of the display apparatus along D1-D2 shown in FIG. 36;

FIG. 38 is a cross-sectional view of the display apparatus along E1-E2 shown in FIG. 36;

FIG. 39 is yet another schematic structural diagram of a display apparatus according to an embodiment of the present disclosure;

FIG. 40 is a cross-sectional view of the display apparatus along F1-F2 shown in FIG. 39;

FIG. 41 is yet another schematic structural diagram of a display apparatus according to an embodiment of the present disclosure;

FIG. 42 is a cross-sectional view of the display apparatus along G1-G2 shown in FIG. 41;

FIG. 43 is a cross-sectional view of the display apparatus along H1-H2 shown in FIG. 41;

FIG. 44 is yet another schematic structural diagram of a display apparatus according to an embodiment of the present disclosure;

FIG. 45 is a cross-sectional view of the display apparatus along I1-I2 shown in FIG. 44;

FIG. 46 is yet another top view of a display apparatus according to an embodiment of the present disclosure;

FIG. 47 is a partial enlarged schematic view of the display apparatus shown in FIG. 45;

FIG. 48 is yet another schematic structural diagram of a display apparatus according to an embodiment of the present disclosure; and

FIG. 49 is a cross-sectional view of the display apparatus along J1-J2 shown in FIG. 48.

### DESCRIPTION OF EMBODIMENTS

For the sake of a better understanding of the technical solutions of the present disclosure, the embodiments of the present disclosure are described in detail below with reference to the accompanying drawings.

It should be noted that the embodiments in the following descriptions are merely some rather than all of the embodiments of the present disclosure. All other embodiments obtained by a person of ordinary skill in the art on the basis of the embodiments of the present disclosure shall fall within the protection scope of the present disclosure.

Terms used in the embodiments of the present disclosure are only for the purpose of describing specific embodiments, and are not intended to limit the present disclosure. Unless otherwise specified in the context, words, such as “a”, “the”, and “this”, in a singular form in the embodiments of the present disclosure and the appended claims include plural forms.

It should be understood that the term “and/or” in this specification merely describes associations between associated objects, and it indicates three types of relationships. For example, A and/or B may indicate that A exists alone, A and B coexist, or B exists alone. In addition, the character “/” in this specification generally indicates that the associated objects are in an “or” relationship.

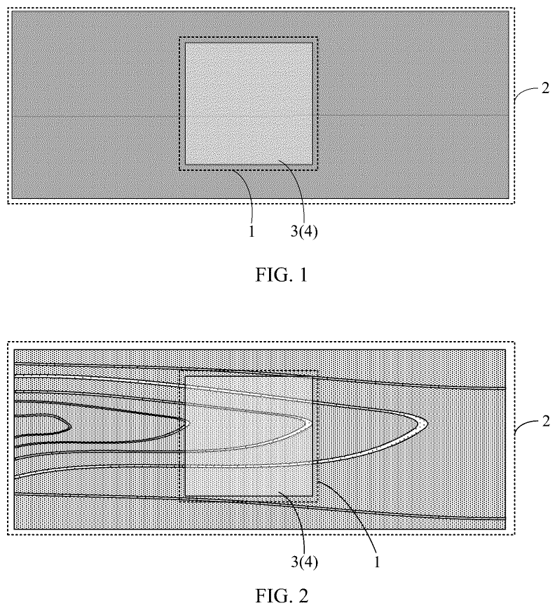

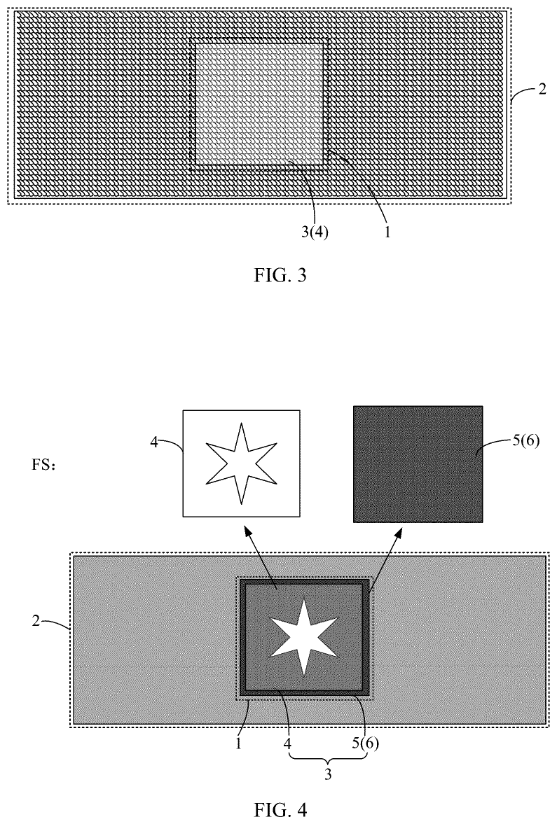

Embodiments of the present disclosure provide a display apparatus. FIG. 1 is a schematic structural diagram of a display apparatus according to an embodiment of the present disclosure, FIG. 2 is another schematic structural diagram of a display apparatus according to an embodiment of the present disclosure, and FIG. 3 is still another schematic structural diagram of a display apparatus according to an embodiment of the present disclosure. As shown in FIG. 1 to FIG. 3, the display apparatus includes a working area 1 and a non-working area 2. The working area 1 can be used to display working image, such as static image like text or dynamic image like videos. The non-working area 2 is used to present a first color or a first pattern, which serves as a decorative background for the display apparatus to optimize an appearance design of the display apparatus. For example, as shown in FIG. 1, the non-working area 2 can display a single color such as black, red, green; alternatively, as shown in FIG. 2 and FIG. 3, the non-working area 2 may present a texture pattern such as wood grain.

The display apparatus further includes a display module 3. The display module 3 includes a transparent display unit 4, which is located in the working area 1 and used to display working image.

In the embodiments of the present disclosure, the display apparatus includes a working area 1 for displaying working image and a non-working area 2 for presenting a decorative background. While the working area 1 displays image normally, the decorative color or pattern presented in the non-working area 2 enhances the aesthetics and fashionability of the appearance of the display apparatus. For example, such a display apparatus can be applied in the automotive field. By displaying a wood grain pattern (the first pattern) in the non-working area 2, it enhances the luxury feel of the interior and achieves a combination of functionality and aesthetics for an in-car display apparatus. Furthermore, in the embodiments of the present disclosure, the display unit for displaying working image is a transparent display unit 4, and the transparency helps reduce the sense of detachment between the image and the surrounding decorative background, contributing to optimizing the overall effect.

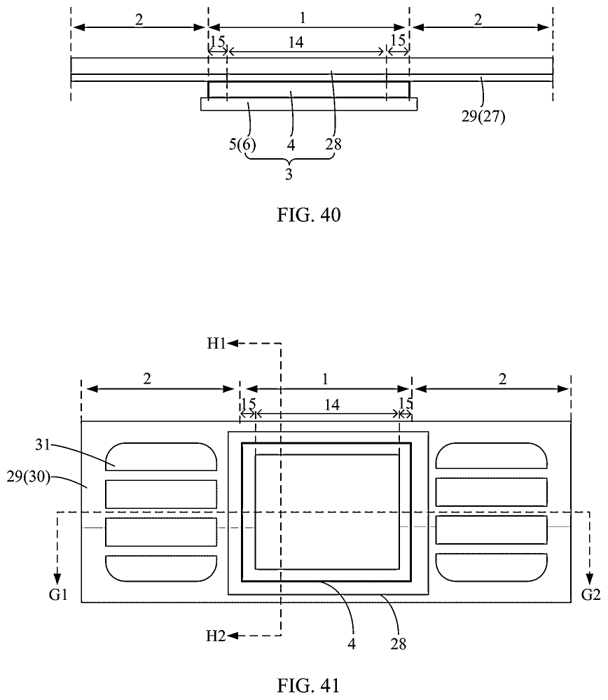

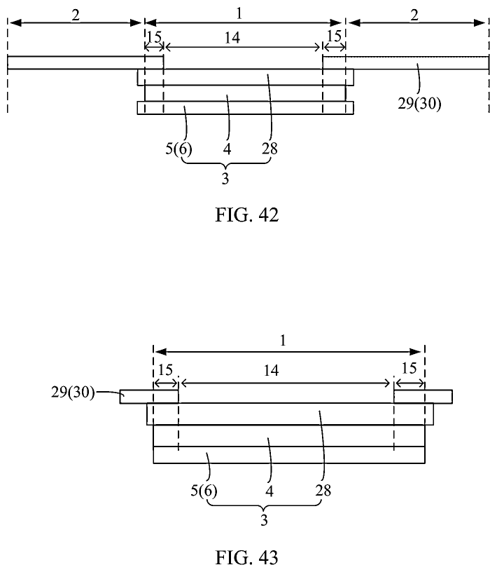

In one implementation, as shown in FIG. 24 to FIG. 26, FIG. 37, FIG. 40, FIG. 42, FIG. 45, and FIG. 49, the display module 3 further includes an electronic paper unit 5, which is located at a side of the transparent display unit 4 away from its display surface. The electronic paper unit 5 includes a first sub-portion 6 located at least in the working area 1. The electronic paper unit 5 can be attached to the frame of the transparent display unit 4.

By adding the electronic paper unit 5 at a backlight side (i.e., non-display surface side) of the transparent display unit 4, the display apparatus can have a more flexible display design. For example, the display apparatus can use the transparent display unit 4 to display complex and colorful dynamic image while using the electronic paper unit 5 to display textual image such as e-book information, thus presenting various types of image.

It should be noted that when the electronic paper unit 5 is used to display e-book information, the transparent display unit 4 can be controlled not to display an image. Since the transparent display unit 4 is transparent, viewers can still clearly see the image displayed by the electronic paper unit 5, even though the electronic paper unit 5 is at the backlight side of the transparent display unit 4.

Additionally, an electronic paper module is relatively thin and light, and adding the electronic paper module does not significantly increase the overall thickness of the display module 3.

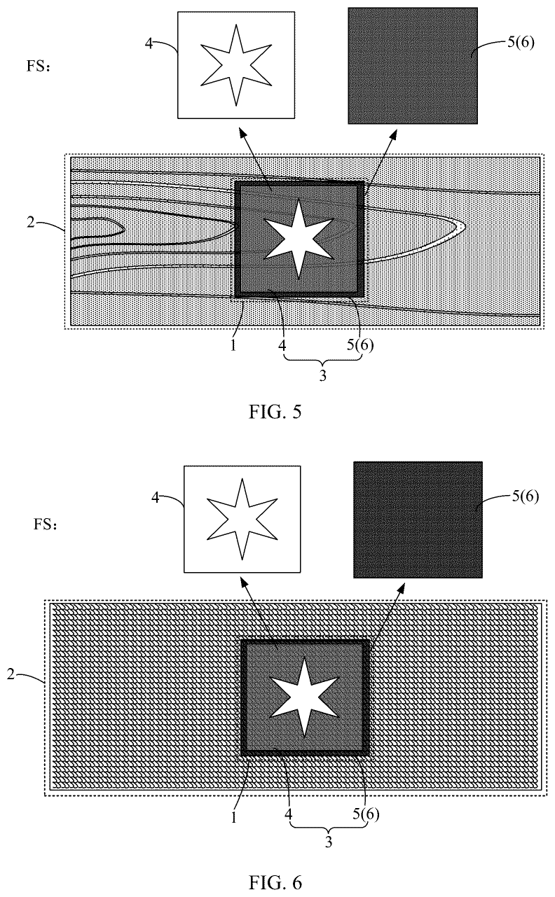

In one practical implementation, FIG. 4 is a schematic diagram of a display apparatus corresponding to FIG. 1 in a first state FS, FIG. 5 is a schematic diagram of a display apparatus corresponding to FIG. 2 in a first state FS, and FIG. 6 is a schematic diagram of a display apparatus corresponding to FIG. 3 in a first state FS. As shown in FIG. 4 to FIG. 6, the display module 3 includes at least the first state FS. The transparent display unit 4 displays working image in the first state FS. In FIG. 4 to FIG. 6, the working image being a hexagon is taken as an example for illustration, and the first sub-portion 6 displays dark-colored image, which specifically may be black image.

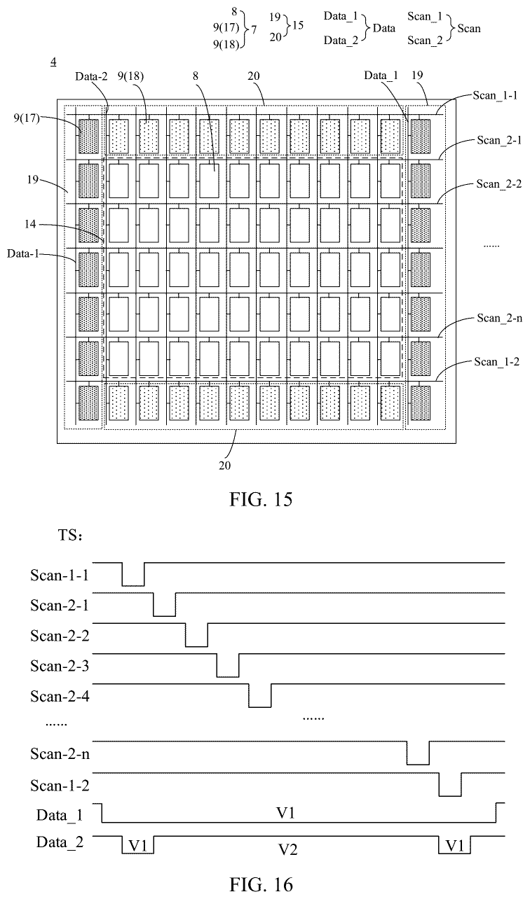

In a sample configuration, with reference to FIG. 15, the transparent display unit 4 includes a display region 14 and a bezel region 15. The display region 14 is used for displaying working image. When the transparent display unit 4 is controlled to display the working image, scan lines Scan scan pixels 7 in the display region 14 line by line, and data lines Data transmit a display data voltage to the scanned pixels 7 to control the pixels 7 to emit light under the driving of the data voltage.

When the transparent display unit 4 displays the working image, by controlling the first sub-portion 6 in the electronic paper unit 5 to display dark-colored image, the contrast of the pattern displayed by the transparent display unit 4 can be increased by using the dark-colored image, allowing viewers to see the image displayed by the transparent display unit 4 more clearly, especially improving a black state display effect of the transparent display unit 4.

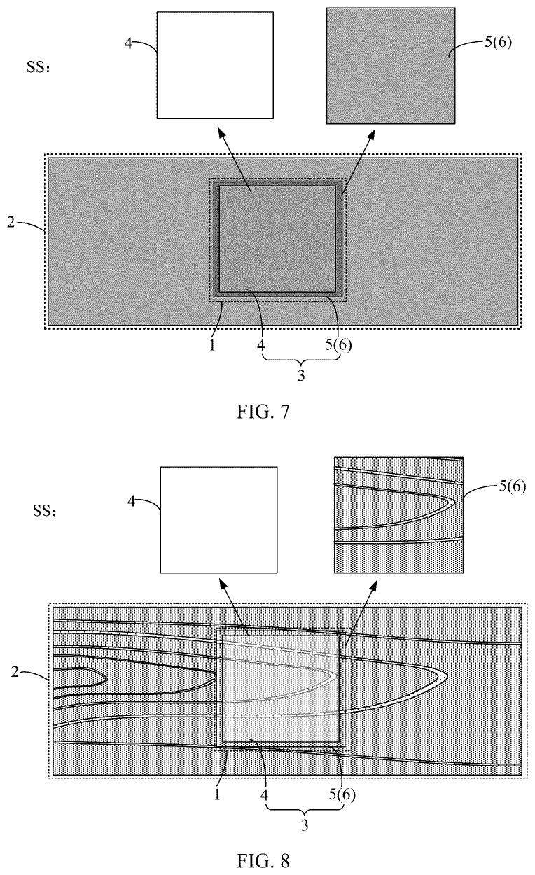

In another implementation, FIG. 7 is a schematic diagram of a display apparatus corresponding to FIG. 1 in a second state SS, FIG. 8 is a schematic diagram of a display apparatus corresponding to FIG. 2 in a second state SS, and FIG. 9 is a schematic diagram of a display apparatus corresponding to FIG. 3 in a second state SS. As shown in FIG. 7 to FIG. 9, the display module 3 includes at least the second state SS. In the second state SS, the transparent display unit 4 does not display working image, and the image displayed by the first sub-portion 6 is related to the first color or the first pattern.

In the embodiments of the present disclosure, the image displayed by the first sub-portion 6 being related to the first color means that the color of the image displayed by the first sub-portion 6 is similar or identical to the first color. For example, when the first color is black, the image displayed by the first sub-portion 6 is also black. Likewise, when the first color is yellow, the image displayed by the first sub-portion 6 is also yellow. The image displayed by the first sub-portion 6 being related to the first pattern means that the pattern of the image displayed by the first sub-portion 6 is similar or identical to the first pattern. For example, when the first pattern is a wood grain pattern, the pattern of the image displayed by the first sub-portion 6 is also a wood grain pattern.

In the second state SS, by controlling the image displayed by the first sub-portion 6 in the electronic paper unit 5 to be related to the first color or the first pattern, the hiding effect of the transparent display unit 4 when not displaying working image can be enhanced. That is, when the transparent display unit 4 does not display working image, colors or patterns in the working area 1 and the non-working area 2 seen by viewers are consistent, increasing the harmony between the transparent display unit 4 and the surrounding decorative environment, making the colors or patterns in the entire display apparatus blend together, thereby improving the visual effect. For example, when the display apparatus is used in the automotive field, the first pattern can be designed as a wood grain pattern. In the second state SS, by controlling the first sub-portion 6 in the electronic paper unit 5 to display the wood grain pattern, the display apparatus as a whole can present a complete wood veneer appearance. Alternatively, when the display apparatus is applied in the smart home field, the first color can be designed as black. In the second state SS, by controlling the first sub-portion 6 in the electronic paper unit 5 to display a black color as well, the display apparatus as a whole can present an all-black appearance.

Furthermore, referring to FIG. 8 again, in the second state SS, a texture of a pattern displayed by the first sub-portion 6 has the same base color and texture color as the texture of the first pattern, ensuring that the texture displayed by the first sub-portion 6 is consistent with the texture of the first pattern, thereby effectively enhancing the hiding effect of the transparent display unit 4 when not displaying working image. The display apparatus achieves an improved overall pattern effect.

It should be noted that when both the first sub-portion 6 and the first pattern have textures, in one configuration, as shown in FIG. 9, in a case that the texture in the first pattern is periodically distributed, i.e., the texture in the first pattern is regularly distributed, the texture displayed by the first sub-portion 6 can be periodically distributed in the same manner. In this case, the pattern displayed by the first sub-portion 6 can be the same as the first pattern. Alternatively, in another configuration, as shown in FIG. 8, when the texture in the first pattern is irregularly distributed, extension paths of the texture in the pattern displayed by the first sub-portion 6 can be designed according to extension paths of the texture in the first pattern, ensuring that the texture displayed by the first sub-portion 6 aligns with the texture extended from the surrounding first pattern, such that textures presented in the working area 1 and the non-working area 2 are coherent as a whole, resulting in an enhanced visual effect.

For example, referring to FIG. 7 again, in the second state SS, the first sub-portion 6 displays the first color.

In this structure, the display apparatus presents only a single color in the non-working area 2. In the second state SS, the first sub-portion 6 also displays a solid-color image of this color, such that the colors in both the working area 1 and the non-working area 2 are identical and continuous visually. This can also effectively enhance the hiding effect of the transparent display unit 4 when not displaying working image.

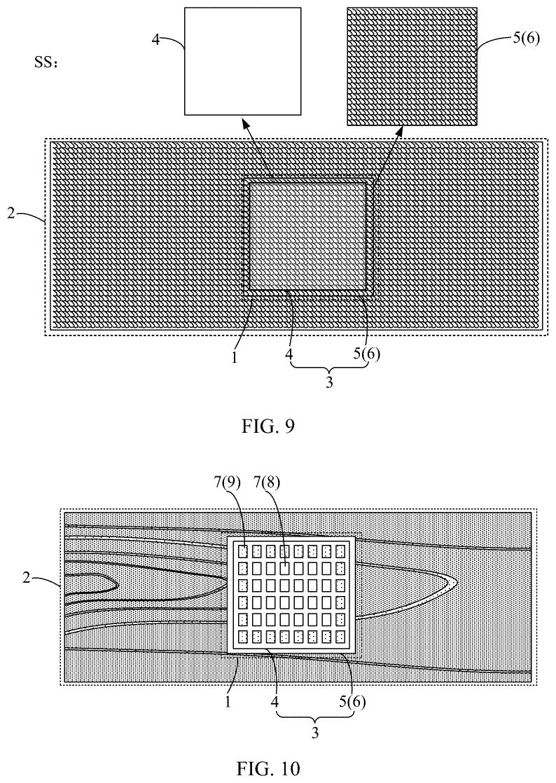

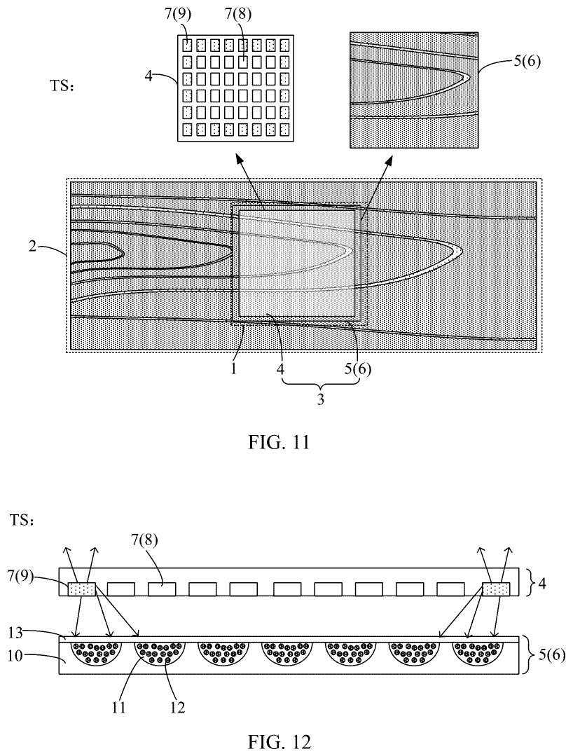

In one implementation, FIG. 10 is yet another top view of a display apparatus according to an embodiment of the present disclosure, FIG. 11 is a schematic diagram of a display apparatus corresponding to FIG. 10 in a third state TS, and FIG. 12 is another schematic diagram of a display apparatus corresponding to FIG. 10 in a third state TS. As shown in FIG. 10 to FIG. 12, the transparent display unit 4 includes pixels 7, which include first pixels 8 and second pixels 9. The display module 3 includes at least the third state TS. In the third state TS, the first pixel 8 does not emit light, and the second pixel 9 emits light. The image displayed by the first sub-portion 6 is related to the first color or the first pattern.

The electronic paper unit 5 generally achieves display through reflection of ambient light. In the third state TS, when the first sub-portion 6 of the electronic paper unit 5 displays image related to the first color or the first pattern, as shown in FIG. 12, by controlling the second pixels 9 in the transparent display unit 4 to emit light, some of the light emitted by the second pixels 9 will be transmitted towards the electronic paper unit 5, thereby increasing the amount of light entering the first sub-portion 6 of the electronic paper unit 5 and improving the display effect of the first sub-portion 6.

In this embodiment of the present disclosure, referring to FIG. 12 again, the electronic paper unit 5 may specifically include a substrate 10. The substrate 10 includes an accommodation hollowed portion 11, and the accommodation hollowed portion 11 includes electrophoretic particles 12. Additionally, the electronic paper unit 5 may further include a color film layer 13 located at a side of the substrate 10, allowing the electronic paper unit 5 to achieve color display and better display image related to the first color or the first pattern.

Furthermore, it should be noted that the third state TS can be the same as the second state SS described above. When the two states are the same, the transparent display unit 4 does not display working image in this state, but some pixels 7 emit light to provide incident light to the electronic paper unit 5. This allows the pattern or texture presented by the electronic paper unit 5 to be visually closer to the pattern or texture presented by the non-working area 2, better hiding the display module.

In one implementation, referring to FIG. 10 again, the second pixels 9 surround the first pixels 8.

It should be noted that in the embodiments of the present disclosure, the second pixels 9 surrounding the first pixels 8 means that the second pixels 9 are arranged around the first pixels 8 in terms of layout or arrangement path, rather than in terms of shape.

It can be understood that when observing the transparent display unit 4, viewers visually focus more on the image presented in the larger central area. To achieve this, in this embodiment of the present disclosure, by arranging the second pixels 9 emitting light in the third state TS to surround the first pixels 8 that do not emit light in the third state TS, while increasing the amount of light entering the electronic paper unit 5 by using the second pixels 9, it also avoids a significant impact of the light emitted by the second pixels 9 on the central area of the transparent display unit 4.

Furthermore, it should be noted that the above-described arrangement only specifies that the second pixels 9 surround the first pixels 8, that is, the second pixels 9 are located between the first pixels 8 and the edge of the transparent display unit 4, but does not specifically define whether the second pixels 9 and the first pixels 8 are located in the display region 14 or the bezel region 15 of the transparent display unit 4. In this embodiment of the present disclosure, the second pixels 9 can be located in the bezel region 15, in the display region 14, or even in both the bezel region 15 and the display region 14, which will be explained in detail in the following embodiments of the present disclosure.

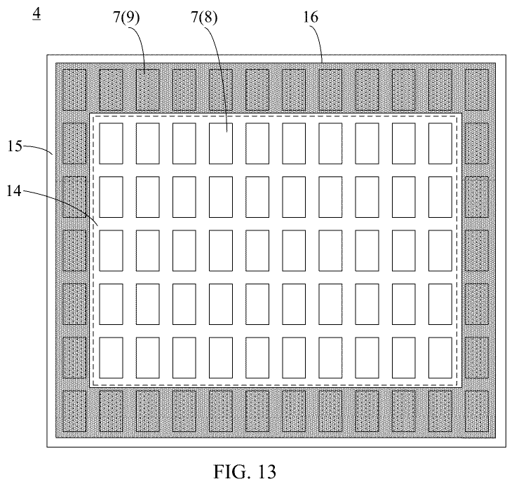

In one implementation, FIG. 13 is a top view of a transparent display unit 4 according to an embodiment of the present disclosure. As shown in FIG. 13, the transparent display unit 4 includes a display region 14 and a bezel region 15. The display region 14 is used to display working image, the first pixels 8 are located in the display region 14, and at least one of the second pixels 9 is located in the bezel region 15.

In the above structure, at least one of the second pixels 9 is located in the bezel region 15. Because these second pixels 9 do not occupy space in the display region 14, in the third state TS, the illumination of these second pixels 9 do not affect the state of the display region 14.

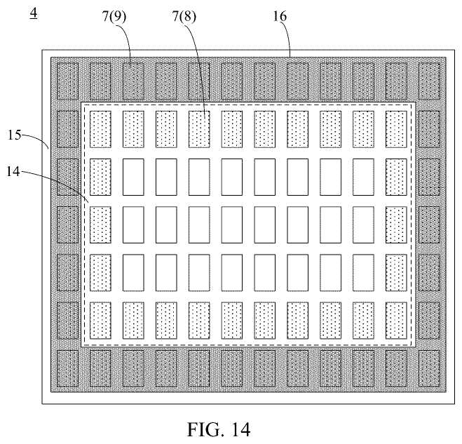

Furthermore, FIG. 14 is another top view of a transparent display unit 4 according to an embodiment of the present disclosure. As shown in FIG. 14, some the second pixels 9 are located in the display region 14 and surround the first pixels 8. In the third state TS, luminance of the second pixels 9 in the display region 14 is lower than luminance of the second pixels 9 in the bezel region 15.

On one hand, the surrounding arrangement of the second pixels 9 can allow a larger number of second pixels 9 to be arranged without affecting the normal display of image that a user needs to see on the transparent display unit 4, such that more incident light is provided to the electronic paper unit 5 in the third state TS. On the other hand, the luminance of the second pixels 9 in the display region 14 is lower than the luminance of the second pixels 9 in the bezel region 15. Therefore, the second pixels 9 in the display region 14 can be used to create a brightness transition between the second pixels 9 in the bezel region 15 and the first pixels 8 in the display region 14, thus the risk of the light emitted by the second pixels 9 being visible to human eyes and the risk of the bezel region being visible to human eyes.

In one implementation, referring to FIG. 13 and FIG. 14 again, the display module 3 further includes a shielding layer 16. The shielding layer 16 is located at a side of the display surface of the transparent display unit 4, and at least one of the second pixels 9 overlaps with the shielding layer 16. In one configuration, the shielding layer 16 can be an ink layer located in the bezel region 15, used to block peripheral circuits of the bezel region 15.

To optimize the light-blocking property of the shielding layer 16, the shielding layer 16 is generally made of a dark material. As a result, the shielding layer 16 forms a distinct black area in the transparent display unit 4. For example, when the shielding layer 16 is an ink layer, the ink layer will form a clearly visible black border on the periphery of the transparent display unit 4. In the third state TS, when the first sub-portion 6 in the electronic paper unit 5 displays image related to the first color or the first pattern, the black border will affect the overall presentation effect of the working area 1 and the non-working area 2. In this regard, in this embodiment of the present disclosure, the second pixels 9 overlap with the shielding layer 16. When light emitted by the second pixels 9 is projected onto the shielding layer 16, it lightens the black border of the blocking area, making a seam color visually lighter to improve the overall presentation effect of the working area 1 and the non-working area 2 in the third state TS.

In one implementation, FIG. 15 is still another top view of the transparent display unit 4 according to an embodiment of the present disclosure. As shown in FIG. 15, the transparent display unit 4 further includes data lines Data. The data lines Data include first data lines Data-1 and second data lines Data-2. The second pixels 9 include first-type second pixels 17 and second-type second pixels 18. The first data line Data-1 is electrically connected to the first-type second pixels 17, and at least one second data line Data-2 is simultaneously electrically connected to the second-type second pixels 18 and the first pixels 8.

In the third state TS, the first data line Data-1 provides a bright-state data voltage V1; the second data line Data-2 provides the bright-state data voltage V1 when scanning the second-type second pixel 18 and a dark-state data voltage V2 when scanning the first pixel 8.

In the above structure, the data lines Data include two types of data lines: the first data lines Data-1 and the second data lines Data-2. Specifically, the first data line Data-1 is electrically connected only to the second pixels 9. Therefore, in the third state TS, the first data line Data-1 can continuously provide the bright-state data voltage V1 to drive the second pixels 9 to emit light. On the other hand, the second data line Data-2 is electrically connected to both the first pixels 8 and the second pixels 9. Since the first pixel 8 and the second pixel 9 have different light emission status in the third state TS, for the voltage provided by the second data line Data-2, scanning conditions of the first pixel 8 and the second pixel 9 need to be considered. Specifically, the second data line Data-2 needs to provide the bright-state data voltage V1 when scanning the second-type second pixel 18 to drive the connected second pixel 9 to emit light and provide the dark-state data voltage V2 when scanning the first pixel 8 to keep the connected first pixel 8 from emitting light.

Furthermore, referring to FIG. 15 again, the transparent display unit 4 includes a display region 14 and a bezel region 15. The display region 14 is used for displaying working image, and the bezel region 15 includes a first bezel region 19 and a second bezel region 20. An arrangement direction of the first bezel region 19 and the display region 14 intersects with an extension direction of the data lines Data, while an arrangement direction of the second bezel region 20 and the display region 14 is parallel to the extension direction of the data lines Data. In other words, the first bezel region 19 can be construed left and right borders, and the second bezel region 20 can be construed as top and bottom borders.

The first pixels 8 are located in the display region 14, the first-type second pixels 17 are located in the first bezel region 19, and the second-type second pixels 18 are located in the second bezel region 20.

Specifically, the transparent display unit 4 further includes scan lines Scan, and an extension direction of the scan lines Scan intersects with the extension direction of the data lines Data. The scan lines Scan include first scan lines Scan-1 and second scan lines Scan-2. The first scan line Scan-1 is electrically connected to the second pixels 9. For example, the first scan line Scan-1 is electrically connected to the second-type second pixels 18, or the first scan line Scan-1 is electrically connected to the first-type second pixels 17 and the second-type second pixels 18. The second scan line Scan-2 is electrically connected to the first-type second pixels 17 and the first pixels 8.

Based on this structure, the statement “the second data line Data-2 provides a bright-state data voltage V1 when scanning the second-type second pixel 18 and provides a dark-state data voltage V2 when scanning the first pixel 8” specifically means that “when the first scan line Scan-1 provides a scanning signal to the second-type second pixel 18, the second data line Data-2 provides the bright-state data voltage V1, and when the first scan line Scan-1 or the second scan line Scan-2 provides a scanning signal to the first pixel 8, the second data line Data-2 provides the dark-state data voltage V2.”

Unlike traditional display units, in this embodiment of the present disclosure, the pixels 7 are also set in the bezel region 15 of the transparent display unit 4. Moreover, the pixels 7 in the bezel region 15 are also electrically connected to the scan lines Scan. Therefore, during one round of scanning from top to bottom or from bottom to top by the scan lines Scan, it should be understood that a complete refresh is performed for all pixels 7 in both the bezel region 15 and the display region 14.

Taking the first scan line Scan-1 being electrically connected to the first-type second pixels 17 and the second-type second pixels 18 as an example, FIG. 16 is a timing diagram of a display apparatus in a third state TS according to an embodiment of the present disclosure. For clarity, in FIG. 15 and FIG. 16, two first scan lines Scan-1 are represented as Scan-1_1 and Scan-1_2, and the first second scan line Scan-2 to n-th second scan lines Scan-2 are represented as Scan-2_1 to Scan-2_n, respectively. In the third state TS, first, the first scan line Scan-1_1 provides an enable level to the first-type second pixel 17 and the second-type second pixel 18 connected thereto. The bright-state data voltage V1 provided by the first data line Data-1 is written into the first-type second pixel 17, driving the first-type second pixel 17 to emit light. The bright-state data voltage V1 provided by the second data line Data-2 is written into the second-type second pixel 18, driving the second-type second pixel 18 to emit light. Then, the second scan lines Scan-2_1 to Scan-2_n sequentially provide an enable level. When the second scan line Scan-2_i provides an enable level to the first-type second pixel 17 and the first pixel 8 connected thereto, the bright-state data voltage V1 provided by the first data line Data-1 is written into the first-type second pixel 17, driving the first-type second pixel 17 to emit light. The dark-state data voltage V2 provided by the second data line Data-2 is written into the first pixel 8, driving the first pixel 8 to remain unlit. Finally, the first scan line Scan-1_2 provides an enable level to the first-type second pixel 17 and the second-type second pixel 18 connected thereto. The bright-state data voltage V1 provided by the first data line Data-1 is written into the first-type second pixel 17, driving the first-type second pixel 17 to emit light. The bright-state data voltage V1 provided by the second data line Data-2 is written into the second-type second pixel 18, driving the second-type second pixel 18 to emit light. In this way, in the third state TS, the second pixel 9 emits light while the first pixel 8 does not emit light.

In the above structure, driving of the second pixels 9 and the first pixels 8 shares a set of scan lines Scan and a set of data lines Data, and the original driving method for the second pixels 9 can be used without the need for a configuring a separate driving method for the second pixels 9.

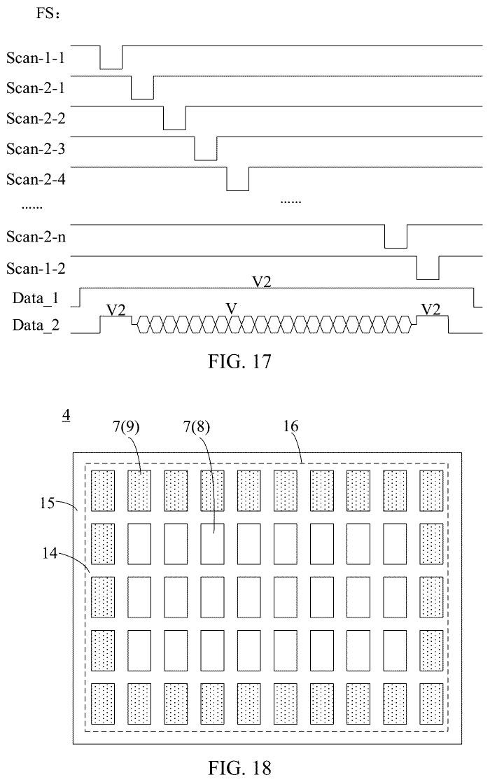

Furthermore, as shown in FIG. 17, FIG. 17 is another timing diagram of a display apparatus in a third state TS according to an embodiment of the present disclosure. With reference to FIG. 15 and FIG. 17, the display module 3 includes at least the first state FS. In the first state FS, the transparent display unit 4 displays working image, and in the electronic paper unit 5, a part located within the working area 1 displays dark-colored image. In the first state FS, the first data line Data-1 provides a dark-state data voltage V2, and the second data line Data-2 provides a dark-state data voltage V2 when scanning the second-type second pixel 18 and provides a display data voltage V when scanning the first pixel 8. The display data voltage V is a data voltage for displaying the working image.

Still, taking the first scan line Scan-1 being electrically connected to the first-type second pixel 17 and the second-type second pixel 18 as an example, in the third state TS, firstly, the first scan line Scan-1_1 provides an enable level to the first-type second pixel 17 and the second-type second pixel 18 connected thereto. The dark-state data voltage V2 provided by the first data line Data-1 is written into the first-type second pixel 17, driving the first-type second pixel 17 to remain unlit. The dark-state data voltage V2 provided by the second data line Data-2 is written into the second-type second pixel 18, driving the second-type second pixel 18 to remain unlit. Then, the second scan lines Scan-2_1 to Scan-2_n sequentially provide an enable level. When the second scan line Scan-2_i provides an enable level to the first-type second pixel 17 and the first pixel 8 connected thereto, the dark-state data voltage V2 provided by the first data line Data-1 is written into the first-type second pixel 17, driving the first-type second pixel 17 to remain unlit. The display data voltage V provided by the second data line Data-2 is written into the first pixel 8, driving the first pixel 8 to emit light. Finally, the first scan line Scan-1_2 provides an enable level to the first-type second pixel 17 and the second-type second pixel 18 connected thereto. The dark-state data voltage V2 provided by the first data line Data-1 is written into the first-type second pixel 17, driving the first-type second pixel 17 to remain unlit. The dark-state data voltage V2 provided by the second data line Data-2 is written into the second-type second pixel 18, driving the second-type second pixel 18 to remain unlit. In this way, in the first state FS, the display region 14 displays the working image.

In one implementation as shown in FIG. 18, which is yet another top view of a transparent display unit 4 according to an embodiment of the present disclosure, the first pixels 8 and the second pixels 9 can also be located within the display region 14. The second pixels 9 surround the first pixels 8. That is, the second pixels 9 are located between the first pixels 8 and the edge of the display region 14. In this case, there is no need to add pixels 7 in the bezel region 15 of the transparent display unit 4, making the structural design simpler.

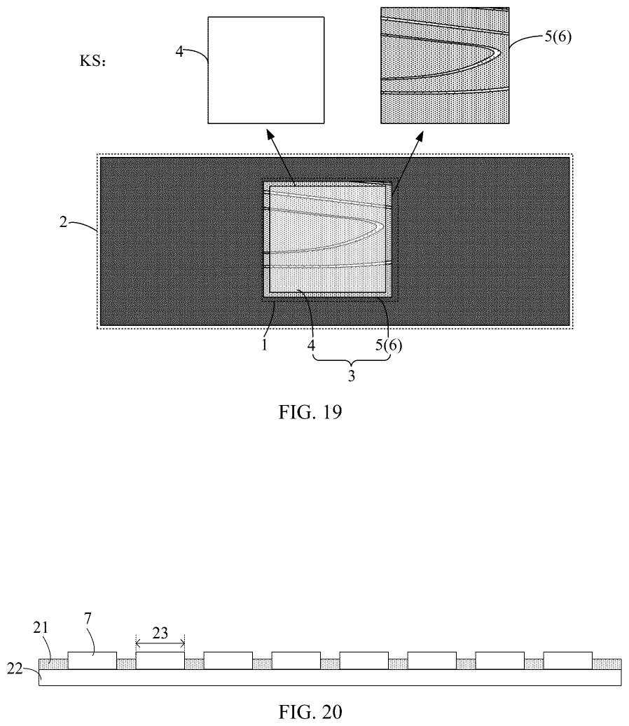

In another implementation, as shown in FIG. 19, which is a schematic diagram of a display apparatus in a fourth state KS according to an embodiment of the present disclosure, the display apparatus includes at least the fourth state KS. In the fourth state KS, the transparent display unit 4 does not display working image. The image displayed by the first sub-portion 6 in the electronic paper unit 5 is unrelated to the first color or the first pattern, that is, the first sub-portion 6 can display any other image to increase the flexibility of the overall appearance of the display apparatus. For example, as shown in FIG. 19, the non-working area 2 appears black, and in the fourth state KS, the first sub-portion 6 can display a wood grain pattern.

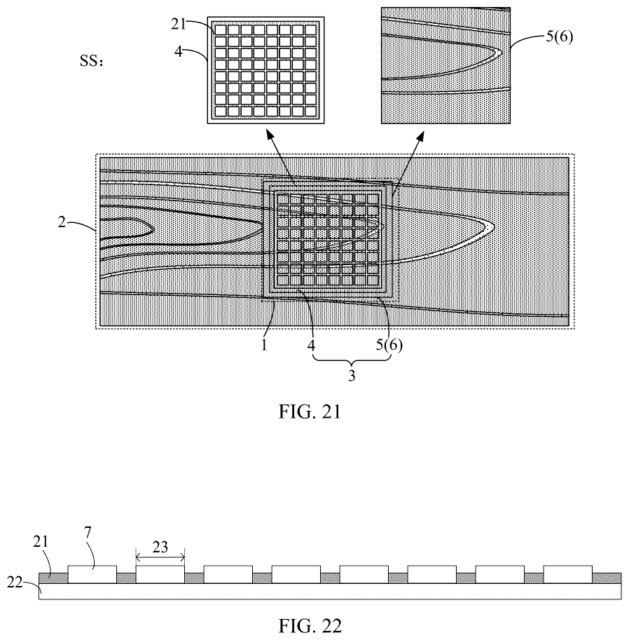

In one implementation, FIG. 20 is a cross-sectional view of a transparent display unit 4 according to an embodiment of the present disclosure, and FIG. 21 is yet another top view of a display apparatus according to an embodiment of the present disclosure. As shown in FIG. 20 and FIG. 21, the transparent display unit 4 includes pixels 7 and a light-shielding layer 21. The pixels 7 and the light-shielding layer 21 are located at a side of the substrate 22. The light-shielding layer 21 includes apertures 23. The aperture 23 exposes a light exiting area of the pixel 7. The color of the light-shielding layer 21 is the same as the background color of the first pattern. For example, if the first pattern is a wood grain pattern, the light-shielding layer 21 can be made of a light-blocking material with the same background color as the wood grain pattern.

Traditionally, the light-shielding layer 21 is a black matrix. In this embodiment of the present disclosure, the color of the light-shielding layer 21 can be further adjusted. When the display apparatus presents the first pattern in the non-working area 2, making the color of the light-shielding layer 21 the same as the background color of the first pattern can make the color of the light-shielding layer 21 close to the color of the first pattern, thereby further enhancing the hiding effect of the transparent display unit 4 when the transparent display unit 4 does not display working image (for example, in the second state SS or the third state TS).

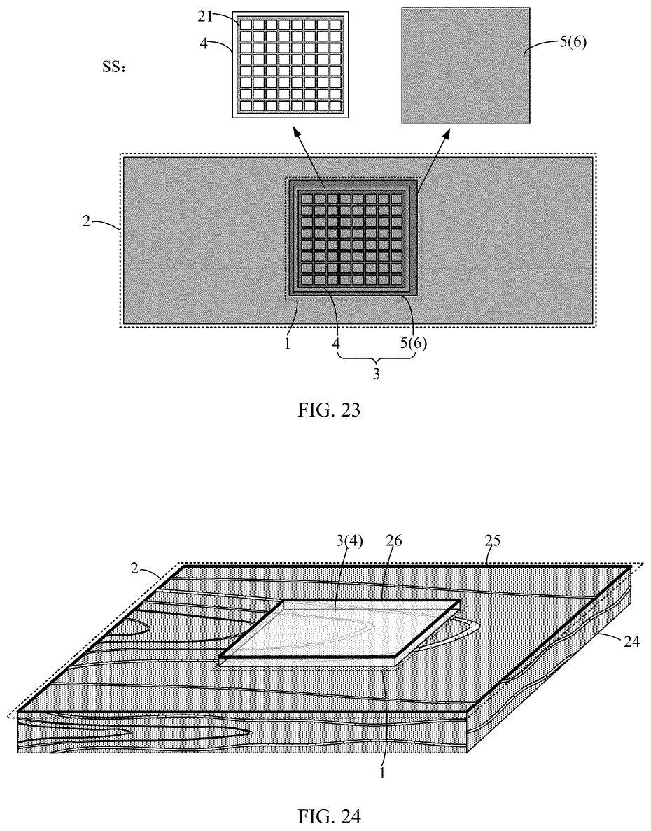

In one implementation, FIG. 22 is another cross-sectional view of a transparent display unit 4 according to an embodiment of the present disclosure, and FIG. 23 is yet another top view of a display apparatus according to an embodiment of the present disclosure. As shown in FIG. 22 and FIG. 23, the transparent display unit 4 includes pixels 7 and a light-shielding layer 21. The light-shielding layer 21 has apertures. The aperture exposes a light exiting area of the pixel 7. The color of the light-shielding layer 21 is the first color. For example, when the first color is black, the light-shielding layer 21 can be made of a light-blocking material matching the color black. This further enhances the hiding effect of the transparent display unit 4 when the transparent display unit 4 does not display working image (for example, in the second state SS or the third state TS).

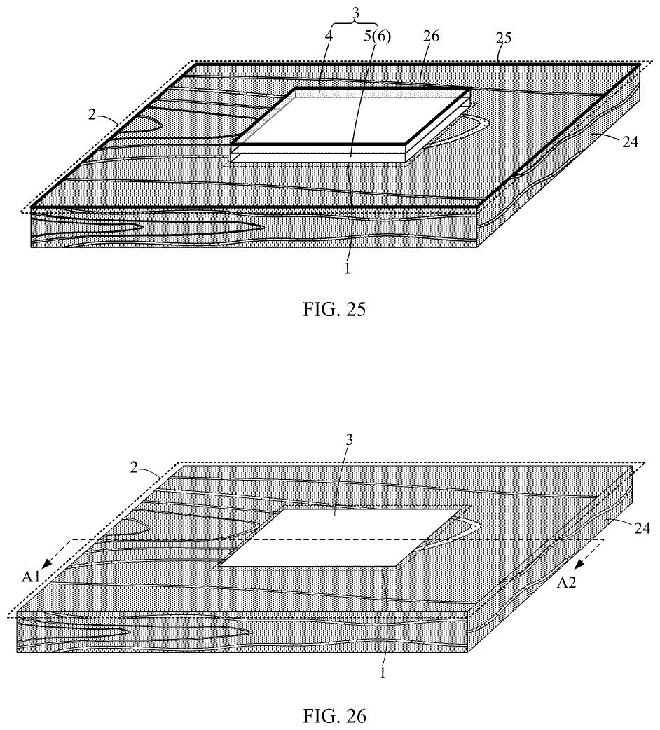

In one implementation, FIG. 24 is a schematic structural diagram of a display apparatus according to an embodiment of the present disclosure, and FIG. 25 is another schematic structural diagram of a display apparatus according to an embodiment of the present disclosure. As shown in FIG. 24 and FIG. 25, the display apparatus further includes a carrier module 24. At least a portion of the carrier module 24 exposed by the display module 3 is located in the non-working area 2 and presents the first color or the first pattern. That is, at least a portion of the carrier module 24 exposed by the display module 3 presents the first color or the first pattern.

It should be noted that the drawings in this embodiment are merely illustrative examples where at least a portion of the carrier module 24 exposed by the display module 3 presents a wood grain pattern. However, as shown in FIG. 1 to FIG. 3, it can be understood that at least a portion of the carrier module 24 exposed by the display module 3 can also present other patterns and any single color. This embodiment of the present disclosure does not illustrate each possibility one by one.

In this structure, the first color or the first pattern used for decoration in the display apparatus is presented by the portion of the carrier module 24 exposed by the display module 3. The carrier module 24 can be any module for carrying an object, such as a carrying platform. The display apparatus with this structure can be applied to more application scenarios.

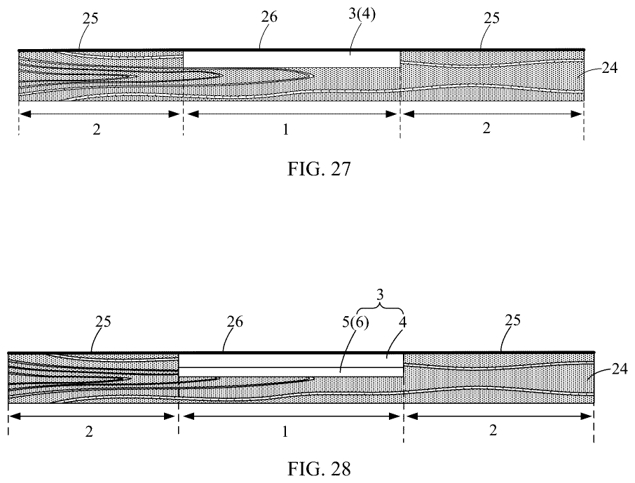

Furthermore, FIG. 26 is still another schematic structural diagram of a display apparatus according to an embodiment of the present disclosure, FIG. 27 is a cross-sectional view of the display apparatus along A1-A2 shown in FIG. 26, and FIG. 28 is another cross-sectional view of the display apparatus along A1-A2 shown in FIG. 26. As shown in FIG. 26 to FIG. 28, the display module 3 is embedded in the carrier module 24, i.e., the carrier module 24 is provided with a groove, and the display module 3 is placed inside the groove.

This configuration can reduce a segment difference between a surface of the display module 3 and a surface of the carrier module 24. When viewers touch the display apparatus with their hands, the surface of the entire display apparatus feels continuous, providing a better visual and tactile experience.

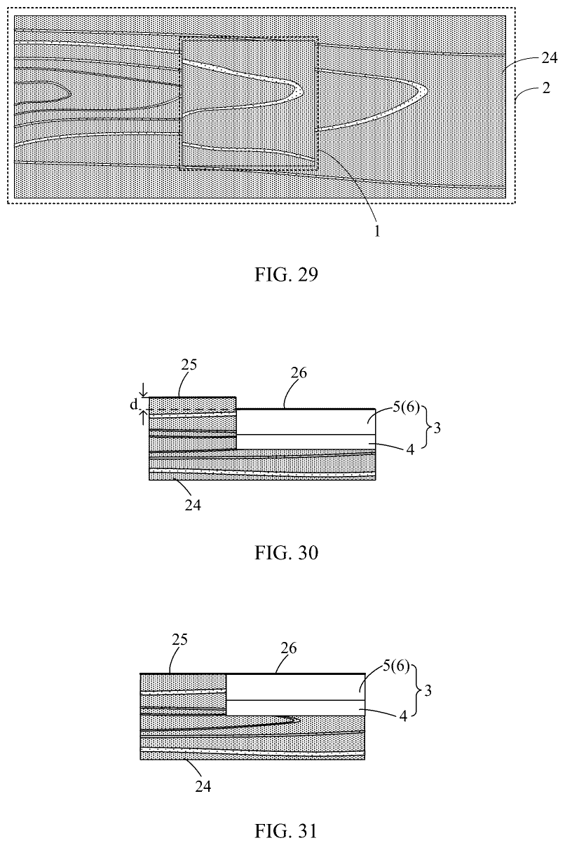

It should be noted that when the carrier module 24 has a wood grain pattern, because a groove needs to be dug out in the carrier module 24, in the carrier module 24, a color or pattern of the surface blocked by the display module 3 may be inconsistent the color or pattern of the surface exposed by the display module 3 when the carrier module 24 is viewed from the top. For example, as shown in FIG. 29, which is a top view of a carrier module 24 according to an embodiment of the present disclosure, in the carrier module 24, the direction of the texture on the surface blocked by the display apparatus is different from the direction of the texture on the surface exposed by the display module 3. However, it can be learned from the foregoing illustration that the display module 3 can include an electronic paper unit 5. Therefore, in the second state SS or the third state TS, when the transparent display unit 4 is not displaying working image, as shown in FIG. 8, it is possible to use the first sub-portion 6 in the electronic paper unit 5 to present a continuous texture that matches the texture on the surface of the carrier module 24 exposed by the display module 3, thereby optimizing the overall pattern presentation effect of the display apparatus.

In other words, the color or pattern of the portion of the carrier module 24 blocked by the display module 3 can be inconsistent with the color or pattern of the portion exposed by the display module 3. That is, in the second state SS or the third state TS, the color or pattern presented by the first sub-portion 6 may be inconsistent with the color or pattern of the surface blocked by the display module 3 in the carrier module 24.

Furthermore, it should be noted that in the embodiments where the display apparatus includes the carrier module 24, whether the display module 3 is placed at a side of the carrier module 24 or embedded in the carrier module 24, the display module 3 can include the transparent display unit 4 only, or include both the transparent display unit 4 and the electronic paper unit 5. When the display module 3 includes both the transparent display unit 4 and the electronic paper unit 5, the operation principles of the transparent display unit 4 and the electronic paper unit 5 have been explained in detail in the previous embodiments and will not be described again herein.

In one implementation, referring to FIG. 24 to FIG. 28 again, the carrier module 24 includes a first surface 25. The display module 3 has a light exiting surface 26. The first surface 25 faces to the same direction as the light exiting surface 26. The first surface 25 is exposed by the light exiting surface 26. The first surface 25 presents the first color or the first pattern. In this case, the first surface 25 of the carrier module 24 with the first color or the first pattern and the light exiting surface 26 of the display module 3 both directly face a viewing angle of the viewer.

Furthermore, as shown in FIG. 30, which is a schematic diagram of a segment difference between a first surface 25 and a light exiting surface 26 according to an embodiment of the present disclosure, the segment difference d between the first surface 25 and the light exiting surface 26 may be less than 100 μm. This avoids the display module 3 protruding too much from the carrier module 24 or sinking too much into the carrier module 24, optimizing the visual and tactile experience.

It should be noted that the segment difference d between the first surface 25 and the light exiting surface 26 being less than 100 μm can include cases where the first surface 25 is higher than the light exiting surface 26, and can also include cases where the light exiting surface 26 is higher than the first surface 25. FIG. 30 illustrates the case where the first surface 25 is higher than the light exiting surface 26 as an example.

In one implementation, as shown in FIG. 31, which is another schematic diagram of a segment difference between a first surface 25 and a light exiting surface 26 according to an embodiment of the present disclosure, the first surface 25 and the light exiting surface 26 are continuous to achieve a more optimal visual and tactile experience.

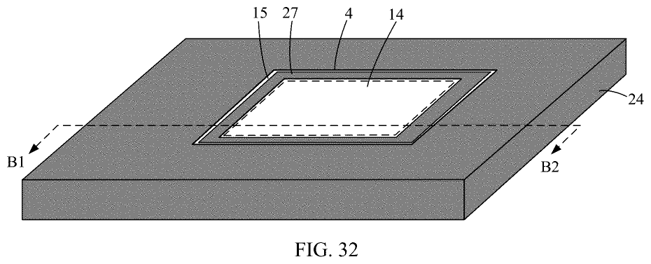

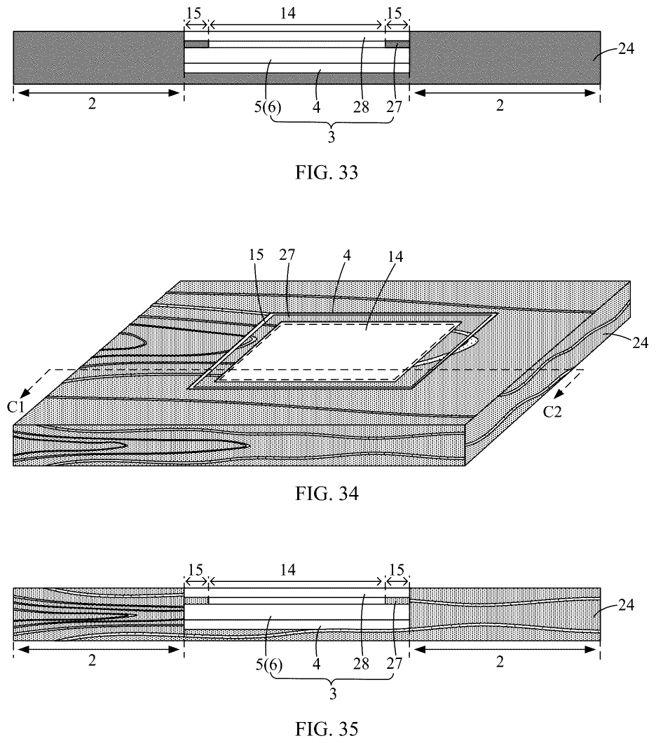

In one implementation, FIG. 32 is yet another cross-sectional view of a display apparatus according to an embodiment of the present disclosure, FIG. 33 is a cross-sectional view of the display apparatus along B1-B2 shown in FIG. 32, FIG. 34 is yet another cross-sectional view of a display apparatus according to an embodiment of the present disclosure, and FIG. 35 is a cross-sectional view of the display apparatus along C1-C2 shown in FIG. 34. As shown in FIG. 32 to FIG. 35, the display module 3 further includes an ink layer 27. The ink layer 27 is located at a side of the display surface of the transparent display unit 4. As shown in FIG. 32 and FIG. 33, the ink layer 27 presents the first color, or as shown in FIG. 34 and FIG. 35, the pattern of the ink layer 27 is related to the first pattern. In this way, when the transparent display unit 4 is not displaying working image, the color or pattern of the ink layer 27 can blend with the first color or first pattern of the surrounding non-working area 2, weakening the boundary formed by the ink layer 27.

The transparent display unit 4 includes a display region 14 and a bezel region 15. The ink layer 27 can specifically be located in the bezel region 15 to block peripheral circuits of the transparent display unit 4.

It should be noted that if the ink layer 27 needs to have the first color, a light-shielding material of the first color can be directly used to form the ink layer 27. If the pattern of the ink layer 27 needs to be related to the first pattern, a silk screen printing technology can be directly used to process the ink layer 27 to have the related pattern.

In one implementation, referring to FIG. 33 and FIG. 35 again, the display module 3 further includes a cover plate 28. The cover plate 28 is located at a side of the display module 3 and is located in the working area 1, such that the screen of the transparent display unit 4 is protected by the cover plate 28.

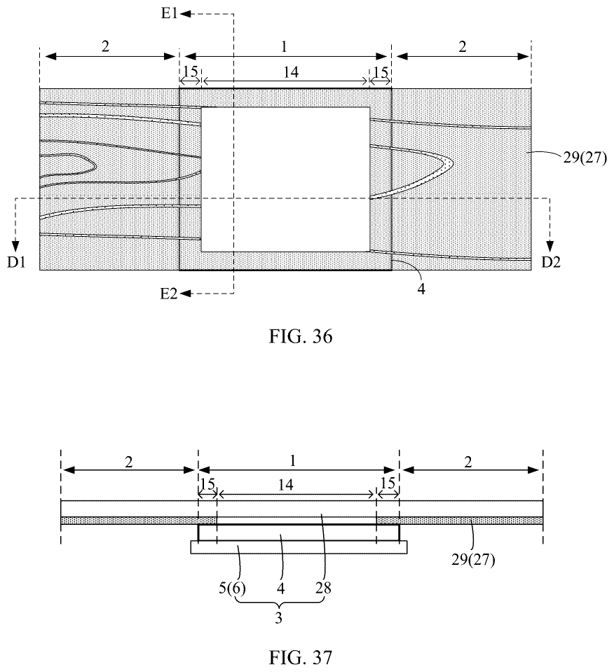

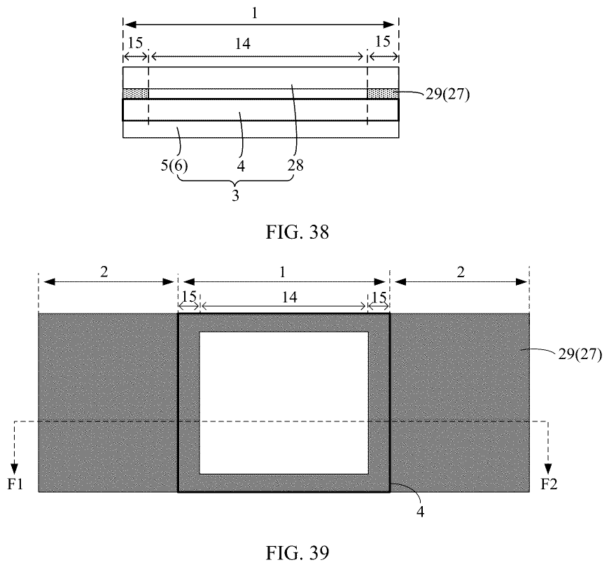

In one implementation, FIG. 36 is yet another schematic structural diagram of a display apparatus according to an embodiment of the present disclosure, FIG. 37 is a cross-sectional view of the display apparatus along D1-D2 shown in FIG. 36, FIG. 38 is a cross-sectional view of the display apparatus along E1-E2 shown in FIG. 36, FIG. 39 is yet another schematic structural diagram of a display apparatus according to an embodiment of the present disclosure, and FIG. 40 is a cross-sectional view of the display apparatus along F1-F2 shown in FIG. 39. As shown in FIG. 36 to FIG. 40, the display module 3 further includes a cover plate 28. The cover plate 28 is located at a side of the display module 3 and at least in the working area 1. The display apparatus further includes a first module 29. The first module 29 is located at a side of the cover plate 28 and at least in the non-working area 2. As shown in FIG. 39 and FIG. 40, the first module 29 presents the first color, or as shown in FIG. 36 to FIG. 38, the first module 29 presents the first pattern.

This arrangement sets the first module 29 at a side of the cover plate 28 and uses the first module 29 to form a decorative background for the display apparatus. In this structure, the decorative color or pattern that the display apparatus needs to present is closer to a light exit side of the display apparatus, resulting in a clearer presentation effect.

In one implementation, referring to FIG. 36 to FIG. 40 again, the cover plate 28 is also located in the non-working area 2. The first module 29 includes an ink layer 27, which is located at a side of the cover plate 28 facing the transparent display unit 4. The ink layer 27 presents the first color or the first pattern.

In this structure, a large-sized cover plate 28 is set, and an ink layer 27 with the first color or the first pattern is set at a side of the cover plate 28. The decorative color or pattern is presented using the ink layer 27. On one hand, an outer side of the display apparatus is covered with the whole cover plate 28. When viewers touch the display apparatus with their hands, they touch an outer surface of the complete cover plate 28. Since the roughness of the outer surface of the cover plate 28 is consistent, the viewers have a better tactile experience. On the other hand, when the ink layer 27 needs to present the first pattern, in this structure, silk screen printing can be directly used to make the ink layer 27 present a specific pattern. The silk screen printing technology is mature and has higher feasibility.

In one implementation, FIG. 41 is yet another schematic structural diagram of a display apparatus according to an embodiment of the present disclosure, FIG. 42 is a cross-sectional view of the display apparatus along G1-G2 shown in FIG. 41, and FIG. 43 is a cross-sectional view of the display apparatus along H1-H2 shown in FIG. 41. As shown in FIG. 41 to FIG. 43, the first module 29 includes a housing 30, which is located at a side of the cover plate 28 away from the transparent display unit 4. The housing 30 presents the first color or the first pattern. For example, when the housing 30 is black, the housing 30 can also be formed using a black ink material, or the housing 30 can be made of plastic.

This structure involves placing the housing 30 on the outer side of the cover plate 28 as the first module 29. By providing the housing 30 with the first color or the first pattern, the display apparatus can present a desired decorative color or pattern in the non-working area 2.

Furthermore, referring to FIG. 41 again, the housing 30 includes a hollowed portion 31, which is located in the non-working area 2. The cover plate 28 does not overlap with the hollowed portion 31.

In this structure, special design is made for the appearance of the display apparatus, which is especially applicable for use in the automotive field. The hollowed portion 31 in the housing 30 can be used as an air outlet for an in-car air conditioning system.

In one implementation, referring to FIG. 36, FIG. 39, and FIG. 41 again, the transparent display unit 4 includes a display region 14 and a bezel region 15. The display region 14 is used to display working image, and the first module 29 overlaps with the bezel region 15. In this case, the portion of the first module 29 that overlaps with the bezel region 15 can be used to shield peripheral circuits of the transparent display unit 4.

For example, as shown in FIG. 41, when the housing 30 overlaps with the bezel region 15, the housing 30 can be used to shield the peripheral circuits of the transparent display unit 4, eliminating the need to set an ink layer between the cover plate 28 and the transparent display unit 4.

Furthermore, it should be noted that in the embodiments where the display apparatus includes the first module 29, the display module 3 can include the transparent display unit 4 only, or include both the transparent display unit 4 and the electronic paper unit 5. When the display module 3 includes both the transparent display unit 4 and the electronic paper unit 5, the operation principles of the transparent display unit 4 and the electronic paper unit 5 have been explained in detail in the previous embodiments and will not be described again herein.

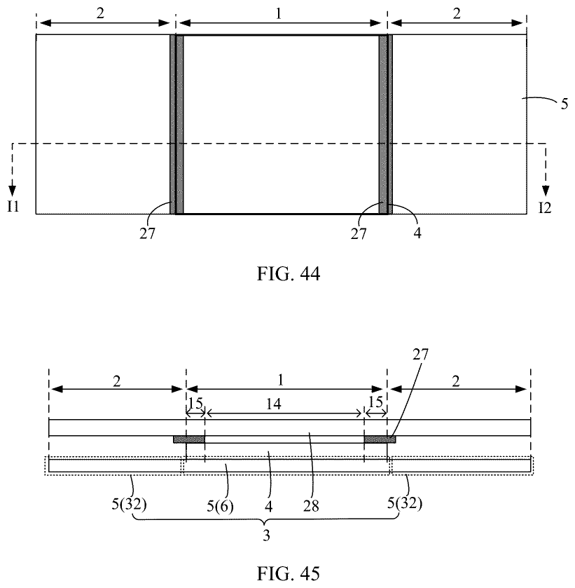

In one implementation, FIG. 44 is yet another schematic structural diagram of a display apparatus according to an embodiment of the present disclosure, and FIG. 45 is a cross-sectional view of the display apparatus along I1-I2 shown in FIG. 44. As shown in FIG. 44 and FIG. 45, the electronic paper unit 5 further includes a second sub-portion 32 located in the non-working area 2. With reference to FIG. 4 to FIG. 9, the second sub-portion 32 presents the first color or the first pattern. Specifically, in the first state FS, the second state SS, and the third state TS, the second sub-portion 32 of the electronic paper unit 5 displays the first color or the first pattern.

In this configuration, by using a large-sized electronic paper unit 5 and placing it in both the working area 1 and the non-working area 2, the second sub-portion 32 in the electronic paper unit 5 can be directly used to display an image with the first color or an image with the first pattern, thereby presenting the decorative background of the display apparatus, without additionally setting another structure to present the decorative background. This simplifies the overall structure of the display apparatus and makes it thinner.

Furthermore, when a decorative pattern is the first pattern, based on this design, in the second state SS and the third state TS, the electronic paper unit 5 can display a complete pattern across both the working area 1 and the non-working area 2. The part of the complete pattern located in the non-working area 2 serves as the decorative background, while the part of the complete pattern located in the working area 1 serves as a decorative background-related pattern that needs to be presented in the working area 1. This results in a higher degree of integrity and coherence in the overall pattern, creating a better effect.

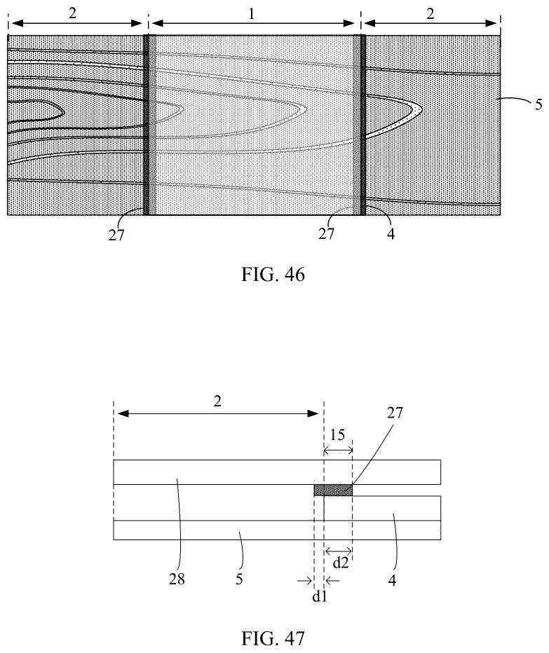

In one implementation, FIG. 46 is yet another top view of a display apparatus according to an embodiment of the present disclosure. With reference to FIG. 44 and FIG. 45, as shown in FIG. 46, the display module 3 further includes a cover plate 28, which is located at a side of the transparent display unit 4 facing away from the electronic paper unit 5. The cover plate 28 is located in both the non-working area 2 and the working area 1, providing protection for the display structure.

The transparent display unit 4 includes a display region 14 and a bezel region 15. The display region 14 is used for displaying working image, and the bezel region 15 is located between the non-working area 2 and the display region 14. The display module 3 further includes an ink layer 27, which is located at a side of the transparent display unit 4 facing the display surface. The ink layer 27 is located at least in the bezel region 15.

Based on this structure, in the non-working area 2, there is an air gap between the cover plate 28 and the second sub-portion 32 of the electronic paper unit 5. Due to a significant difference in refractive index between the cover plate 28 and the air, when the electronic paper unit 5 displays an image, for example, when the electronic paper unit 5 displays a wood grain pattern in the second state SS as depicted in FIG. 46, the ambient light will undergo noticeable refraction at an interface between the cover plate 28 and the air. This leads to a significant visual segment difference at the junction of the non-working area 2 and the working area 1, causing textures at that location to appear incoherent. To address this, in this embodiment of the present disclosure, an ink layer 27 is placed in the bezel region 15. The ink layer 27 can be used to create a black border at the junction of the non-working area 2 and the working area 1, forming a distinctive border effect, which effectively conceals the visual segment difference caused by refraction.

In one implementation, referring to FIG. 45 again, the ink layer 27 is also located in the non-working area 2 to conceal a visual segment difference between the front view and the oblique view.

Furthermore, as shown in FIG. 47, which is a partial enlarged schematic view of the display apparatus shown in FIG. 45, the part of the ink layer 27 in the non-working area 2 has a first width d1, and the part of the ink layer 27 in the bezel region 15 has a second width d2. To avoid an excessive border width for aesthetic purposes, the first width d1 can be made smaller than the second width d2.

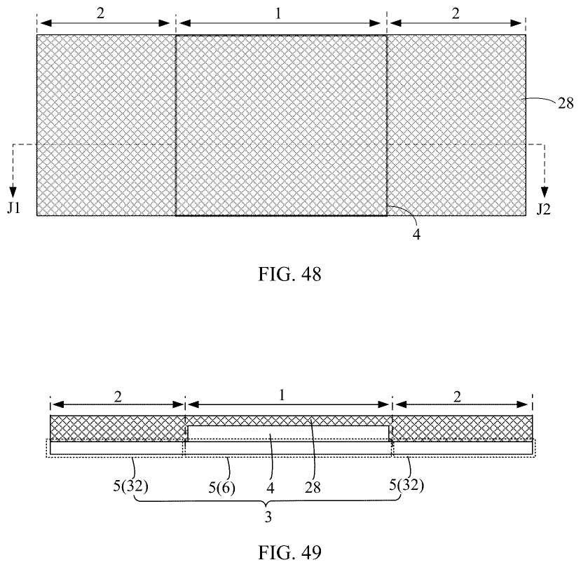

In one implementation, FIG. 48 is yet another schematic structural diagram of a display apparatus according to an embodiment of the present disclosure, and FIG. 49 is a cross-sectional view of the display apparatus along J1-J2 shown in FIG. 48. As shown in FIG. 48 and FIG. 49, the display module 3 further includes a cover plate 28, which is located in the non-working area 2 and the working area 1. The transparent display unit 4 is embedded into a side of the cover plate 28 close to the electronic paper unit 5.

In this structure, by embedding the transparent display unit 4 in the cover plate 28, the gap between the cover plate 28 and the electronic paper unit 5 in the non-working area 2 can be reduced, or the cover plate 28 can even make direct contact with the electronic paper unit 5. This effectively overcomes the foregoing issue of visual segment difference caused by the refractive index difference between the cover plate 28 and the air.

Moreover, when the transparent display unit 4 is embedded in the cover plate 28, the cover plate 28 provides more comprehensive protection for the transparent display unit 4 and the electronic paper unit 5, resulting in improved protective performance.

Additionally, in this embodiment of the present disclosure, the transparent display unit 4 and the electronic paper unit 5 can share a power source or a printed circuit board to achieve a higher level of integration.

The above descriptions are merely preferred embodiments of the present disclosure, and are not intended to limit the present disclosure. Any modifications, equivalent replacements, improvements, and the like made within the spirit and principle of the present disclosure shall fall within the protection scope of the present disclosure.

Finally, it should be noted that the above embodiments are merely intended to describe the technical solutions of the present disclosure, rather than to limit the present disclosure. Although the present disclosure is described in detail with reference to the above embodiments, persons of ordinary skill in the art should understand that they may still make modifications to the technical solutions described in the above embodiments or make equivalent replacements to some or all technical features thereof, without departing from the essence of the technical solutions in the embodiments of the present disclosure.

What is claimed is:

1. A display apparatus, comprising a working area and a non-working area, wherein the non-working area presents a first color or a first pattern, and
wherein the display apparatus further comprises a display module, and the display module comprises a transparent display unit located in the working area.

2. The display apparatus according to claim 1, wherein the display module further comprises an electronic paper unit located at a side of the transparent display unit away from a display surface of the transparent display unit, and the electronic paper unit comprises a first sub-portion located at least in the working area.

3. The display apparatus according to claim 2, wherein the display module has at least a first state, and wherein, in the first state, the transparent display unit displays working image, while the first sub-portion displays dark-colored image.

4. The display apparatus according to claim 2, wherein the display module comprises at least a second state, and wherein, in the second state, the transparent display unit does not display working image, while image displayed by the first sub-portion is related to the first color or the first pattern.

5. The display apparatus according to claim 4, wherein in the second state, a texture of a pattern displayed by the first sub-portion has a same background color and texture color as a texture of the first pattern.

6. The display apparatus according to claim 4, wherein, in the second state, the first sub-portion displays the first color.

7. The display apparatus according to claim 2, wherein the transparent display unit comprises pixels, and the pixels comprise first pixels and second pixels; and
the display module comprises at least a third state, and wherein, in the third state, the first pixel does not emit light, the second pixel emits light, and image displayed by the first sub-portion is related to the first color or the first pattern.

8. The display apparatus according to claim 7, wherein the second pixels surround the first pixels.

9. The display apparatus according to claim 7, wherein the transparent display unit comprises a display region and a bezel region, the display region is configured to display working image, the first pixels are located in the display region, and at least one of the second pixels is located in the bezel region.

10. The display apparatus according to claim 9, wherein part of the second pixels is located in the display region and surround the first pixels; and
in the third state, luminance of the second pixels in the display region is lower than luminance of the second pixels in the bezel region.

11. The display apparatus according to claim 7, wherein the display module further comprises a shielding layer located at a side of the display surface of the transparent display unit, and at least one of the second pixels overlaps with the shielding layer.

12. The display apparatus according to claim 7, wherein the transparent display unit further comprises data lines, and the data lines comprise first data lines and second data lines;
the second pixels comprise first-type second pixels and second-type second pixels; the first data lines are electrically connected to the first-type second pixels, and at least one of the second data lines is simultaneously electrically connected to the second-type second pixels and the first pixels; and
in the third state, each of the first data lines provides a bright-state data voltage, while each of the second data lines provides the bright-state data voltage when scanning the second-type second pixels and provides a dark-state data voltage when scanning the first pixels.

13. The display apparatus according to claim 12, wherein the transparent display unit comprises a display region and a bezel region; the display region is configured to display working image; the bezel region comprises a first bezel region and a second bezel region; an arrangement direction of the first bezel region and the display region intersects with an extension direction of the data lines, while an arrangement direction of the second bezel region and the display region is parallel to the extension direction of the data lines; and
the first pixels are located in the display region, the first-type second pixels are located in the first bezel region, and the second-type second pixels are located in the second bezel region.

14. The display apparatus according to claim 13, wherein the display module comprises at least a first state, and in the first state, the transparent display unit displays the working image, while in the electronic paper unit, a part located within the working area displays dark-colored image; and
in the first state, the first data line provides the dark-state data voltage, and the second data line provides the dark-state data voltage when scanning the second-type second pixels and provides a display data voltage when scanning the first pixels.

15. The display apparatus according to claim 1, wherein the transparent display unit comprises pixels and a light-shielding layer, the light-shielding layer comprises apertures, exposing a light exiting area of the pixel; and
a color of the light-shielding layer is the same as a color of at least part of the first pattern.

16. The display apparatus according to claim 1, wherein the transparent display unit comprises pixels and a light-shielding layer, the light-shielding layer comprises an aperture exposing a light exiting area of the pixel; and
a color of the light-shielding layer is the first color.

17. The display apparatus according to claim 1, wherein the display apparatus further comprises a carrier module, and at least a portion of the carrier module exposed by the display module is located in the non-working area and presents the first color or the first pattern.

18. The display apparatus according to claim 17, wherein the display module is embedded into the carrier module.

19. The display apparatus according to claim 17, wherein the carrier module comprises a first surface, the display module has a light exiting surface, the first surface and the light exiting surface face to a same direction, the first surface is exposed by the light exiting surface, and the first surface has the first pattern.

20. The display apparatus according to claim 19, wherein a segment difference between the first surface and the light exiting surface is less than 100 μm.

21. The display apparatus according to claim 19, wherein the first surface and the light exiting surface are continuous.

22. The display apparatus according to claim 17, wherein the display module further comprises an ink layer located at a side of the display surface of the transparent display unit, the ink layer presents the first color, or a pattern of the ink layer is related to the first pattern.

23. The display apparatus according to claim 1, wherein the display module further comprises a cover plate, and the cover plate is located at a side of the display module and at least in the working area; and
the display apparatus further comprises a first module, the first module is located at a side of the cover plate and at least in the non-working area, and the first module presents the first color or the first pattern.

24. The display apparatus according to claim 23, wherein the cover plate is also located in the non-working area, the first module comprises an ink layer, the ink layer is located at a side of the cover plate facing the transparent display unit, and the ink layer presents the first color or the first pattern.

25. The display apparatus according to claim 23, wherein the first module comprises a housing, the housing is located at a side of the cover plate away from the transparent display unit, and the housing presents the first color or the first pattern.

26. The display apparatus according to claim 25, wherein the housing comprises a hollowed portion, the hollowed portion is located in the non-working area, and the cover plate does not overlap with the hollowed portion.

27. The display apparatus according to claim 23, wherein the transparent display unit comprises a display region and a bezel region, the display region is configured for displaying working image, and the first module further overlaps with the bezel region.

28. The display apparatus according to claim 2, wherein the electronic paper unit further comprises a second sub-portion located in the non-working area, and the second sub-portion presents the first color or the first pattern.

29. The display apparatus according to claim 28, wherein the display module further comprises a cover plate, the cover plate is located at a side of the transparent display unit facing away from the electronic paper unit, and the cover plate is located in the non-working area and the working area;
the transparent display unit comprises a display region and a bezel region, the display region is used for displaying working image, and the bezel region is located between the non-working area and the display region; and
the display module further comprises an ink layer, the ink layer is located at a side of the transparent display unit facing the display surface, and the ink layer is located at least in the bezel region.

30. The display apparatus according to claim 29, wherein the ink layer is further located in the non-working area.

31. The display apparatus according to claim 30, wherein a part of the ink layer located in the non-working area has a first width, a part of the ink layer located in the bezel region has a second width, and the first width is smaller than the second width.

32. The display apparatus according to claim 28, wherein the display module further comprises a cover plate, the cover plate is located in the non-working area and the working area; and
the transparent display unit is embedded into a side of the cover plate close to the electronic paper unit.
